(19) United States
(12) Patent Application Publication
(10) Pub. No.: US 2013/0325659 A1
(43) Pub. Date: Dec. 5, 2013

(54) Systems and Methods for User Goal Oriented Mapping

(71) Applicants: Parag Shekher, San Francisco, CA (US); Rahul Shekher, Menlo Park, CA (US)

(72) Inventors: Parag Shekher, San Francisco, CA (US); Rahul Shekher, Menlo Park, CA (US)

(21) Appl. No.: 13/844,943

(22) Filed: Mar. 16, 2013

Related U.S. Application Data
(60) Provisional application No. 61/654,810, filed on Jun. 1, 2012.

(51) Int. Cl. G06Q 30/06; G01C 21/00

(52) U.S. Cl. CPC G06Q 30/0639; G01C 21/00
USPC 705/26.9; 701/400

(57) ABSTRACT

A system and method for user goal oriented mapping is disclosed. In some embodiments, an initial user location may be received. One or more user goals may be received. For example, a first product to purchase and a second product to purchase may be received from the user. The system and method may determine locations where the first product and the second product may be purchased. In some embodiments, a notice may be transmitted to the locations where the first product and the second product may be purchased. Directions may be provided from the initial user location to the first and second locations.

### RELATED APPLICATION

This application claims priority under 35 U.S.C. §119(e) to U.S. Provisional Patent Application 61/654,810 filed on Jun. 1, 2012 and entitled “Systems and Methods for User Goal Oriented Mapping,” which is hereby incorporated by reference in its entirety and for all purposes.

### FIELD

The present disclosure is related to the field of mapping. In some embodiments, the present disclosure relates towards systems and methods for user goal oriented mapping.

### BACKGROUND

Conventional mapping techniques route based on user provided locations. A user may specify that he or she would like to go from a first location to a second location. For example, a user may input an address for a first location and an address for a second location and a mapping system may provide routing directions from the address of the first location to the address of the second location.

However, conventional mapping techniques are contingent upon the user knowing the exact order of addresses that the user wants to go to. If the user does not know of an exact address, then conventional mapping techniques will not be useful to the user.

Accordingly, it is highly desirable to develop systems and methods for providing user goal oriented mapping.

### SUMMARY

A system, comprising at least one processor and memory, may provide user goal oriented mapping. In some embodiments, the system may receive an initial user location, a first user goal, and a second user goal. A first location to accomplish the first user goal and a second location to accomplish the second user goal may be determined. A first notice may be transmitted to the first location and a second notice may be transmitted to the second location. In some embodiments, the first notice may comprise information to identify the user and the first user goal and the second notice may comprise information to identify the user and the second user goal. The system may provide routing directions from the initial user location to the first and second locations.

In some embodiments, the first notice comprises a first approximate time of arrival of the user at the first location and the second notice comprises a second approximate time of arrival of the user at the second location. The first and second approximate time of arrivals may be based on the routing directions.

In some embodiments, a start time associated with the user may be received. The first and second approximate time of arrival may be further based on the start time associated with the user.

In some embodiments, the information of the first notice and may be used to reserve a first item to be purchased at the first location and the second notice may be used to reserve a second item to be purchased at the second location.

In some embodiments of the disclosure, one or more time restrictions may be received. The determining of the first location and the second location may be further based on the time restrictions.

In some embodiments, the time restrictions may comprise times that the user specifies to arrive at the first location and the second location.

In some embodiments of the disclosure, first operating hours for the first location and second operating hours for the second location may be received. The determining of the first location and the second location may be based on whether the first and second operating hours satisfy the one or more time restrictions.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a flow diagram of an example method for user goal oriented mapping in accordance with an embodiment.

FIG. 2 illustrates a flow diagram of a method for user goal oriented mapping with restriction-based determination and location contacting in accordance with an embodiment.

FIG. 3 illustrates a client-server network environment of an example system for user goal oriented mapping in accordance with an embodiment.

FIG. 4 illustrates a graphical user interface for user goal oriented mapping in accordance with an embodiment.

FIG. 5 illustrates how an example of user goal oriented mapping in accordance with some embodiments.

FIG. 6 illustrates an example method for user goal oriented mapping comprising inventory querying in accordance with some embodiments.

FIG. 7 illustrates an embodiment of a computer system and a network system that incorporates the user goal oriented mapping systems and methods of the present invention.

### DETAILED DESCRIPTION

The systems and methods disclosed herein relate to mapping. In some embodiments, the systems and methods relate to providing user goal oriented mapping.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

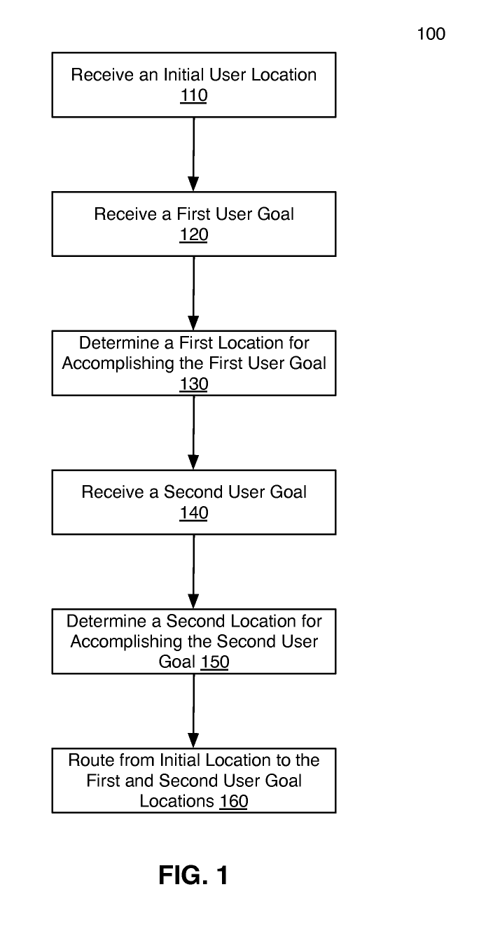

FIG. 1 illustrates a flow diagram of a method 100 to provide user goal oriented mapping in accordance with some embodiments of the disclosure. In general, the method 100 receives an initial location from a user and at least one user goal and creates a map or route (e.g., comprising directions) from the initial location to a location where the user goal may be accomplished.

As seen in FIG. 1, at block 110, an initial location may be received from a user. In some embodiments, the initial location may be received from a user via a web page or software application. For example, a user may enter his or her home address as an initial location on a web page. In some embodiments, the location may be a merchant location, park, business center, hotel, residential locale, tourist site, airport or other transportation stations, street address, neighborhood, city, landmark, longitude and/or latitude coordinates, or other locations. Alternatively, the initial location may be automatically filled on the web page by a web browser, browser plugin or add-on, toolbar, operating system, or other software. In some embodiments, the user's location may be automatically determined from an Internet Protocol (IP) address of the user. In the same or alternative embodiments, the initial location may comprise the user's current location as determined by Global Position System (GPS), Assisted GPS, from a user's cell phone, in-car computer or GPS system, or any other service or system.

At block 120, a first user goal may be received. For example, the user may specify that he or she wants to see a specific movie at a movie theater. The user goal may also comprise a category goal. For example, the user may want to purchase a book or watch a movie without specifying an exact type of book to purchase or movie to watch. In some embodiments, a user goal may comprise any or all of an item to purchase or observe, an activity, service, specific directions, location, setting, tourist location, store, or category. As such, a user may enter his or her goal to accomplish a particular task.

At block 130, a first location may be determined from the goal received from the user. In some embodiments, a database associated with a merchant may be queried for the availability of the goal. For example, if the user's goal is to purchase the book “Great Expectations,” one or multiple databases of a merchant's inventory may be queried for the availability of “Great Expectations.” In the same or alternative embodiments, a database associated with a different server may be queried. For example, the availability of “Great Expectations” may be verified by interfacing with a server associated with a bookstore and querying its associated database. An acknowledgement may be received to signal the status of the item at the location. If the item is available, the location may be signaled as an appropriate location for the user to accomplish the goal. If the item is unavailable, the location may be bypassed, ignored, and/or skipped as a location to accomplish the user goal received from block 120. As such, an item's availability may be verified at a merchant's location (e.g., a store) and, if available, provided as a location to accomplish the goal received from the user. Sources to query for availability of items comprise databases, files, or any other collections of data or information of store inventory. In some embodiments, the databases, files, or collections of data contain additional information in addition to store inventory data, such as store operating hours (e.g., days that the location may be open and/or hours during a day that the location may be open such that the goal may be accomplished at the location during a particular time), prices, reputation or reviews, or other data describing the merchant's operating conditions.

In the same or alternative embodiments, the user goal may be a general category specification. For example, the user may specify a goal to peruse “books.” As such, databases, files, or other collections of data may be queried to verify whether the merchant has books available or generally carries books. In another embodiment, the item may be recognized as falling within a particular category and then specific databases or sources involving merchants likely to carry the item may be queried. For example, the user may specify an item such as “Tickle Me Elmo.” The item may be recognized as a toy and thus the inventories of merchants that sell toys may be queried. The identification of an item to its general category may comprise semantic search, querying a database, or accessing a website or other source to verify how it is categorized. As an example of accessing a website, a user may specify that he or she wishes to purchase the book “Great Expectations” and a third-party website may be queried to check how “Great Expectations” is categorized. As such, a user provided item is identified to fall within one or more particular categories. In an embodiment, if an item is associated with multiple categories, the system may prompt the user to select one or more categories such that the unselected categories may be ignored. Thus, the possible merchant locations to accomplish the user provided goal may be narrowed and a more limited number of inventory sources may be queried. For example, a user may specify an item such as “Great Expectations.” The item may be recognized as either a book or a movie, the user may select the book category, and then databases associated with bookstores may be queried as to the availability of the book “Great Expectations.”

At block 140, a second user goal may be received from the user. The second user goal may comprise a second activity that the user wishes to accomplish (e.g., a product that the user wishes to purchase). At block 150, a second location for accomplishing the second user goal may be determined. In some embodiments, such determination may be similar to the disclosure as related to block 130.

At block 160, a route from the initial location received from block 110 to the locations to accomplish the user goals received from blocks 130 and 150 may be determined. In some embodiments, the initial location received from block 110 may route to the location to accomplish the first user goal followed by the route from the location to accomplish the first user goal to the location to accomplish the second user goal. In other embodiments, the location to accomplish the second user goal may be routed to from the initial location first. As such, the route may not be required to follow the order of user goals as provided by the user. The route may comprise driving, walking, biking, ferry, or other modes of transportation. Thus, the route may be for a car on streets and highways. The route may also exclude certain features such as toll roads, interstates, low speed limit roads, construction, or other features.

In some embodiments, only one user goal may be received. Alternatively, several user goals may be received and processed within the method 100. In other embodiments, receiving an initial location of a user 110 and receiving a first user goal 120 may be performed in any order or in parallel. As such, several of the operations 110, 120, 130, 140, and 150 may be performed in any order or in parallel.

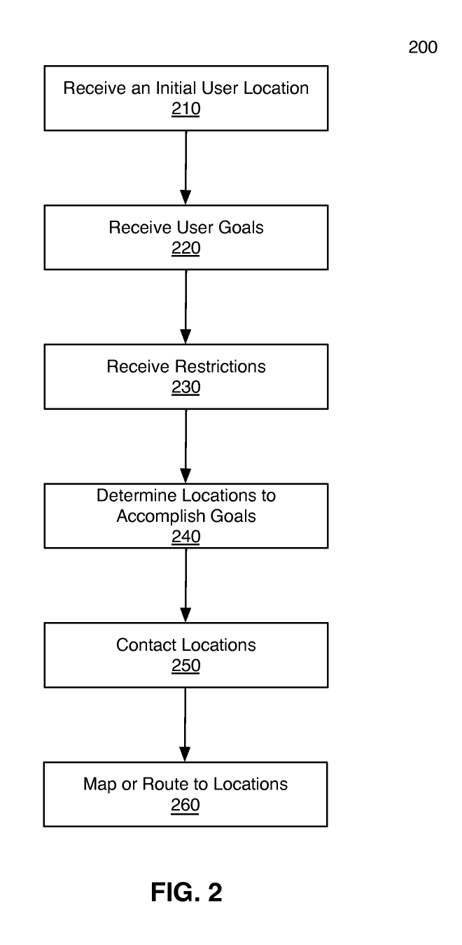

FIG. 2 illustrates a flow diagram of a method 200 for providing user goal oriented mapping with restriction-based determination and location contacting in accordance with some embodiments. In general, the method 200 receives an initial location from a user and at least one user goal and creates a map or route from the user's initial location to a location where the user goal may be accomplished while taking into account user or system provided restrictions.

As seen in FIG. 2, at block 210, an initial location from the user may be received. At block 220 one or more goals from a user may be received. For example, the one or more goals may comprise an activity (e.g., a hike) and/or an item to purchase. In some embodiments, at block 230, one or more restrictions may be received. Alternatively, a system, cell phone, server, computer, software, or other source may select one or more restrictions automatically. For example, a user or a system may specify that user wishes to obtain a route with the least mileage. A restriction may also include time periods. For example, the restriction may specify that the user must accomplish his or her goals between 2:00 pm and 4:00 pm. Another restriction may take into account priority values. For example, the restriction may specify that purchasing a copy of “Great Expectations” has a higher priority than going to a park. In another embodiment, a restriction may include a price range, maximum or minimum price, discount, or condition including but not limited to used or new for one or more of the goals. A restriction may also include a price range, maximum price, minimum price, or discount for the purchase of all items in the aggregate provided as user goals from block 220. Thus, the goals may be to purchase the book “Great Expectations,” an XBOX360 video game console, and a gallon of milk with a restriction of a maximum combined price of $300. As such, in some embodiments, a maximum price may be associated with the accomplishing (e.g., purchasing) of one or more goals (e.g., items to purchase). Single or multiple restrictions may be received. As an example, a goal may be that the user wishes to purchase “Great Expectations” with the restrictions comprising a purchase window of 6:00 pm to 8:00 pm with a maximum price of $20. A restriction may also include reputation. For example, a restriction may be to go to merchants rated a certain level, either through reviews, ratings, rankings or other types of information.

At block 240, locations to accomplish the goal or goals may be determined by considering the restrictions received by block 230. For example, the user goals received at block 220 may be to purchase the book “Great Expectations,” an XBOX 360, and milk and a restriction received at block 230 may be to obtain a route with the least mileage. As previously described with the disclosure relating to block 130, in one embodiment, the locations of possible stores may be collected and the inventories queried to determine if the goals may be accomplished at particular locations (e.g., items may be purchased and/or are available). Following the acquisition of possible locations, the restrictions received from block 230 may be applied to determine the best locations among the possible locations to accomplish the user goals received at block 220. Thus, locations to purchase “Great Expectations,” an XBOX 360, and milk will be determined whereby the route from the initial location received at block 210 to the locations to accomplish the goals may be determined such that the route will have a minimum overall distance. In another embodiment, possible locations to accomplish the goal may be collected, data associated with stores may be compared with the restrictions, and then if the store is a suitable candidate to accomplish the goal, its inventory may be queried. For example, a user may specify that he or she wishes to purchase the book “The Road” with the restriction of after 6 p.m. (e.g., a time restriction for store operating hours). Stores that sell books may be collected along with information regarding the stores' operating hours. The inventories of stores open after 6 p.m. may then be queried for the availability of “The Road.” As such, restrictions may include any or all of mileage limitations, store operating hours, time windows or limits, prices, discounts, reputation, and priority.

At block 250, the locations selected where the user goals may be accomplished may be contacted. For example, if the user goal is to purchase “Great Expectations” and a particular bookstore has been determined as a location to accomplish the user goal to purchase “Great Expectations,” the store may be contacted. For example, the store may receive a message that the user may be coming to purchase “Great Expectations.” In some embodiments, the store may receive a notification to reserve a copy of “Great Expectations” for the user. The message may be via server-to-server communications, email, text message, phone call, instant message, or other means of communication. Thus, the merchant may have notification that the user is coming and can have the book “Great Expectations” ready for the user to pick up the book. The message may contain the user's identification information, credit card information or other payment information, other locations to accomplish the goal, route, restrictions, and/or any other data.

At block 260, a route from the initial location received at block 210 to the locations where the goals may be accomplished as determined at block 250 may be determined. The route is determined by considering the locations to accomplish the goals received at block 240 and restrictions at block 230. Thus, an optimal route may be proposed. For example, if the user goals are to purchase the book “Great Expectations,” the DVD “Lawrence of Arabia,” go to a Bank of America office, and purchase milk with a least mileage restriction, a route may be proposed wherein both “Great Expectations” and “Lawrence of Arabia” may be purchased at a particular electronics store with a nearby Bank of American branch and grocery store to purchase milk. The order of the route from the initial location to subsequent locations to accomplish the goals may be in an order to best accomplish the goals with the selected restriction.

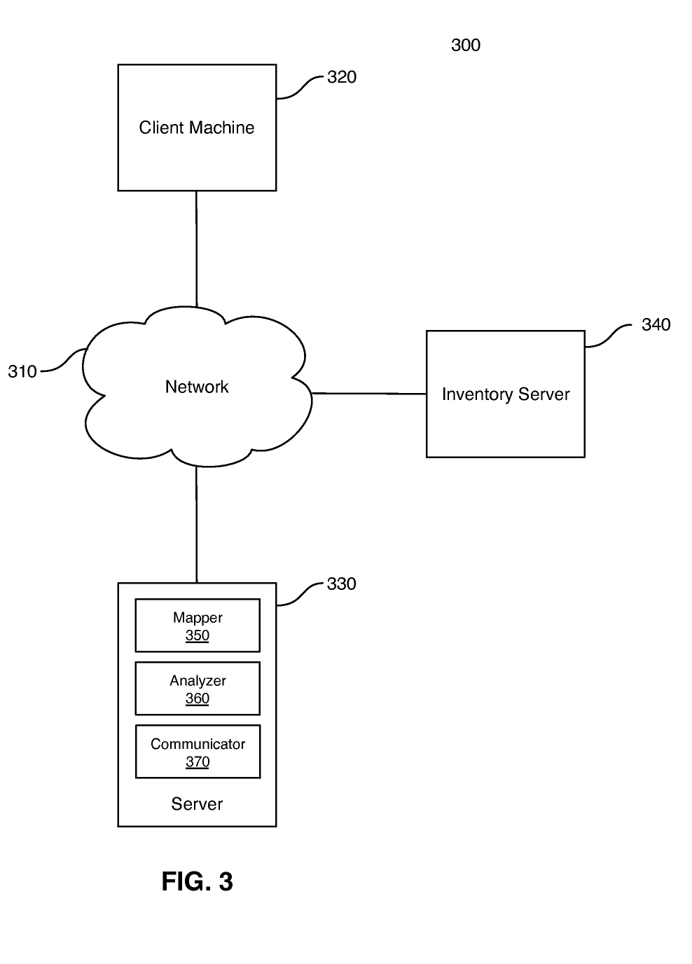

FIG. 3 illustrates a block diagram of an embodiment of the disclosure as implemented in a client-server environment. In general, the environment 300 comprises a client machine 320, server 330, and database 340 communicatively coupled via a network 310. The server 330 comprises a mapper 350, analyzer 360, and a communicator 370.

As seen in FIG. 3, a server 330 may receive an initial location, user goals, and restrictions from client machine 320. The client machine 320 may be a cell phone, computer, tablet, in-car system, or other device. The analyzer 360 may process the incoming data and may query database 340 via the network 310 to acquire the locations to accomplish the user goals. The mapper 350 may provide mapping or routing data based on the locations to accomplish the user goals selected by the analyzer 360. The map and/or route may be generated on server 330. In another embodiment, goal location data may be returned to client machine 320 and a final map or route may be generated locally. In an embodiment, a communicator 370 may be included to transmit data to another server. For example, the user's goal of purchasing “Great Expectations” and user data comprising identification, payment information, schedule, route, or other data may be transmitted to a selected bookstore to prepare for the user's arrival.

In some embodiments, database 340, mapper 350, analyzer 360, and communicator 370 may be on the client machine 320. In other embodiments, database 340, mapper 350, analyzer 360, and communicator 370 may be split among many servers. For example, database 340 may reside on a first server, mapper 350 on a second server, both analyzer 360, and communicator 370 on a third server, with a separate client machine 310. In alternative embodiments, communicator 370 may be removed. Thus, each of 320, 330, 340, 350, 360, and 370 may be together, separated, or missing. In some embodiments, the server 330 may perform the methods as disclosed with relation to FIGS. 2 and 3.

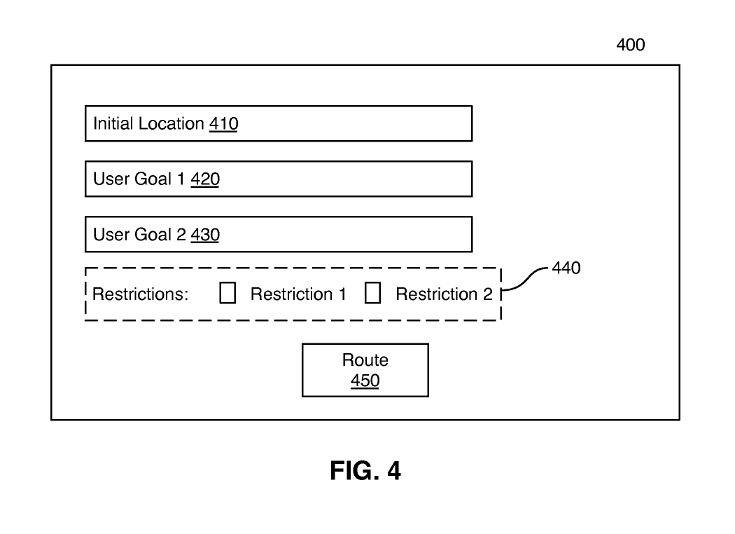

As seen in FIG. 4, the webpage 400 and the systems and methods disclosed herein may comprise a web application running on a web server. Client computers may access the webpage 400 or web application over a network. For example, a client computer may access the webpage 400 and provide initial location 410, user goals 420 and 430, and restrictions 440 that may be transmitted to the web server after pressing the route button 450. As such, the web server receives the user information and may evaluate and/or analyze the information to determine the locations to accomplish the user goals and generate a map with the appropriate route.

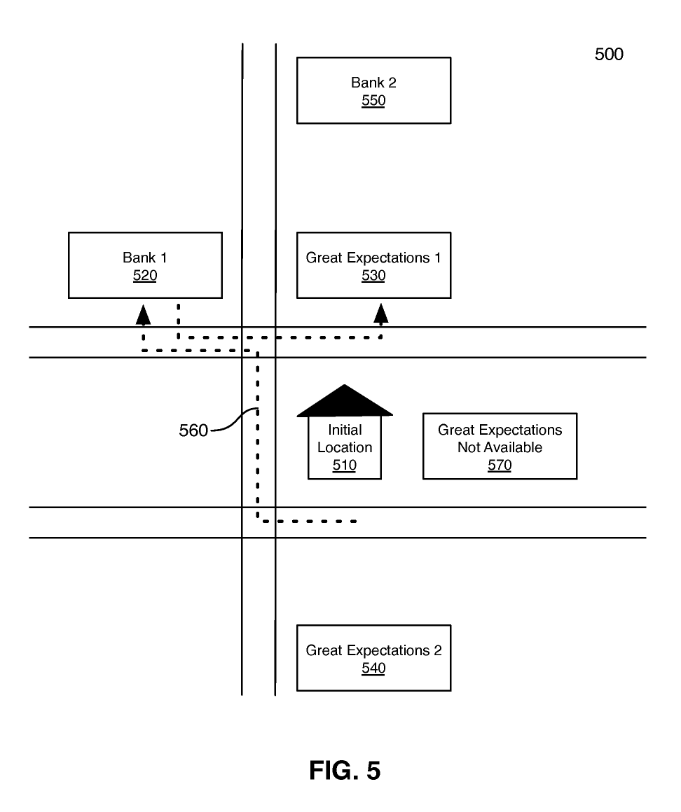

FIG. 5 illustrates how user goal oriented mapping may be implemented in accordance with some embodiments. As seen in FIG. 5, map 500 may provide a route 560 from initial location 510 to ‘Bank 1’ 520 and “Great Expectations” 1 530 where route 560 is determined by a restriction specifying the least mileage. Though user goals of going to a bank and purchasing “Great Expectations” may be accomplished at locations ‘Bank 2’ 550 and “Great Expectations” 2 540, the route 560 has been established because traveling from Initial Location 510 to Bank 1 520 and “Great Expectations” 1 530 provides the user with the least mileage. Thus, locations to accomplish the user goals at “Great Expectations” 2 540 and ‘Bank 2’ 550 may be ignored. “Great Expectations” Not Available 570 represents a bookstore whose location provides a route better suited to a least mileage restriction, but is ignored because its inventory has been queried and found to not carry the item (e.g., the book ‘Great Expectations’).

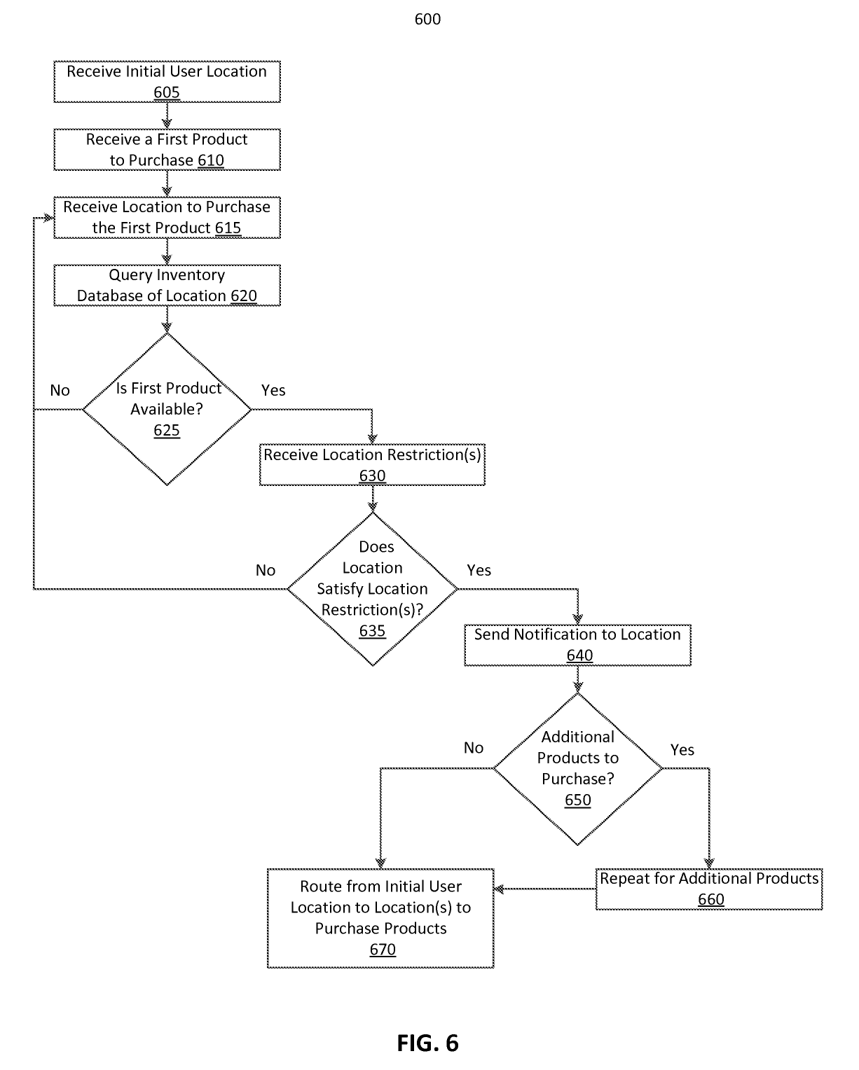

FIG. 6 illustrates an example method for user goal orienting mapping or routing in accordance with some embodiments. In general, the method 600 may receive an initial user location and one or more products and provide a mapping or routing from the initial user location to one or more locations corresponding to the one or more products.

As seen in FIG. 6, at block 605, an initial user location may be received. For example, the initial user location may be an address submitted by the user, a GPS location of the user, or any other method of detecting or learning a user's location as discussed in the present disclosure. At block 610, a first product to purchase may be received. For example, the user may indicate a specific product to purchase. At block 615, a location to purchase the first product may be identified. For example, a store where the first product may be purchased may be identified. At block 620, an inventory database of the location received at block 615 may be queried. In some embodiments, the inventory database of the location may comprise an item or product inventory associated with the location or store. At block 625, a determination may be made whether the first product may be purchased at the location or store identified at block 615. For example, the inventory database of the location or store may be queried to determine if the location or store currently has the first product in stock and/or available for purchase. If the location or store does not have the first product in stock and/or available for purchase, then the method 600 may identify and/or receive, at block 615, another location to purchase the first product. If the location or store does have the first product in stock and/or available for purchase, then the method 600 may receive, at block 630, location restrictions. In some embodiments, the location restrictions may comprise system restrictions or user input restriction as previously discussed. In the same or alternative embodiments, the location restrictions may comprise a user input that specifies a time restriction corresponding to a location to purchase the first product. For example, the time restriction may correspond to a time, time window (e.g., start time and end time), and/or hours that the location or store is open (e.g., a time where the user may purchase the first product).

As seen in FIG. 6, at block 635, a determination may be made as to whether the location or store satisfies the location restrictions received at block 630. For example, a determination may be made as to whether operating hours corresponding to the location (e.g., store operating hours) satisfy and/or meet the location restrictions from the user. For example, the location restriction may comprise a time restriction where the user would like to arrive at the location at a particular time or time period and the determination at block 635 may comprise a determination if the user's particular time or time period to arrive is within the operating hours corresponding to the location. If it is determined that the location or store does not satisfy the location restrictions, then the method 600 may receive and/or determine, at block 615, another location to purchase the first product. However, if it is determined that the location or store does satisfy the location restrictions, then, at block 640, a notification may be sent and/or transmitted to the location or store. For example, a notice to place the first product on hold for the user (e.g., such that the first product is reserved for the user) may be transmitted to the location or store, a notice to the location or store that the user is expecting to arrive at the location or store at a particular time from the user's route or schedule (e.g., an estimated time of arrival or approximate time of arrival for the user to arrive the location based on an initial start time of the user and the routing directions of the user), other locations on the user's route, other user goals and/or products, or other such information (e.g., relating to an identification of the user and/or an identification of the first product associated with the user) may be transmitted to the location or store. In some embodiments, the notice may comprise marketing information, demographic information of the user, other products that the user intends to purchase (e.g., if the user has indicated that he or she wishes to purchase a first product and a second product, a notice may be transmitted to the first location where the user intends to purchase the first product that the user also intends to purchase the second product at a second location). In the same or alternative embodiments, the notification may be sent to a merchant such as a restaurant and indicate information such as an identification of the user and an approximate time of arrival such that the restaurant may place a reservation for the user (e.g., based on the user's identification for a time based on the approximate time of arrival).

As seen in FIG. 6, at block 650, a determination may be made as to whether the user has identified additional products to purchase. If the user has not indicated additional products to purchase, then at block 670, a route from the initial user location to the location or store corresponding to the first product may be determined. If the user has indicated additional products to purchase, then at block 660, additional locations where the additional products may be purchased may be determined. For example, the steps any or all of blocks 610, 615, 620, 625, 630, 635, 640, and/or 650 may be repeated for each additional product that the user has indicated that he or she wishes to purchase. After a location for each of the products has been determined, then at block 670, a route from the initial user location to the locations to purchase the products may be determined.

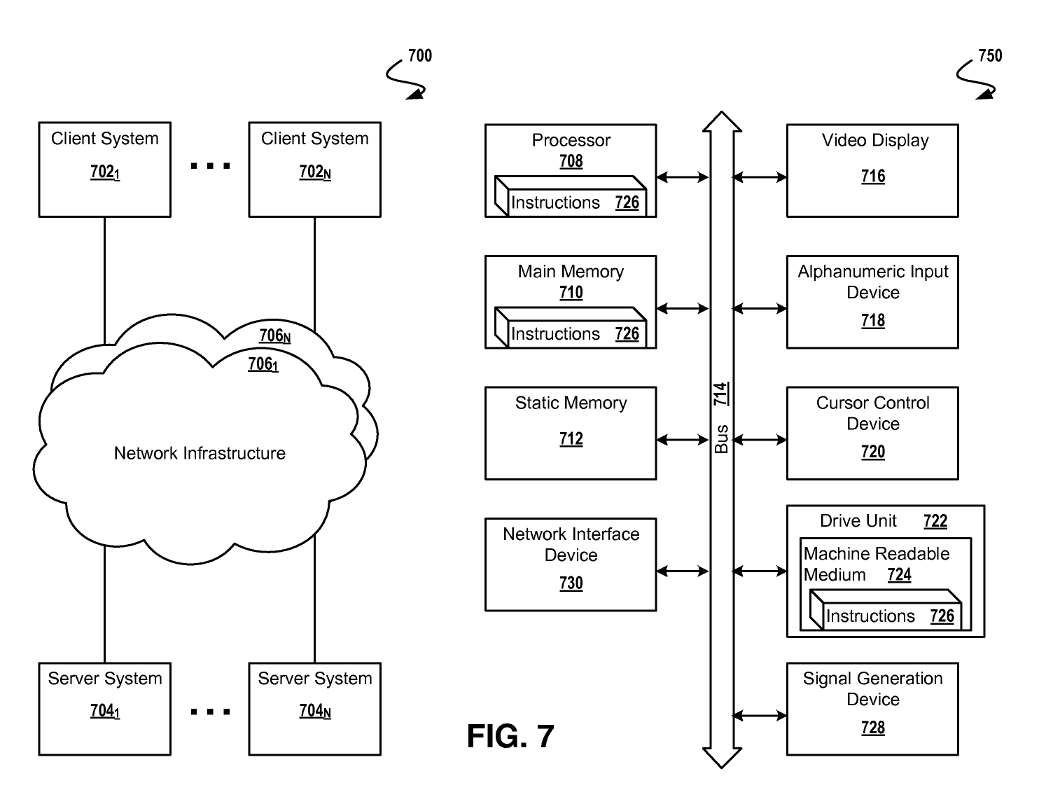

FIG. 7 is a diagrammatic representation of a network 700, including nodes for client computer systems 702₁ through 702_{N}, nodes for server computer systems 704₁ through 704_{N}, nodes for network infrastructure 706₁ through 706_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 750 includes a processor 708 (e.g. a processor core, a microprocessor, a computing device, etc.), a main memory 710 and a static memory 712, which communicate with each other via a bus 714. The machine 750 may further include a display unit 716 that may comprise a touch-screen, or a liquid crystal display (LCD), or a light emitting diode (LED) display, or a cathode ray tube (CRT). As shown, the computer system 750 also includes a human input/output (I/O) device 718 (e.g. a keyboard, an alphanumeric keypad, etc.), a pointing device 720 (e.g. a mouse, a touch screen, etc.), a drive unit 722 (e.g. a disk drive unit, a CD/DVD drive, a tangible computer readable removable media drive, an SSD storage device, etc.), a signal generation device 728 (e.g. a speaker, an audio output, etc.), and a network interface device 730 (e.g. an Ethernet interface, a wired network interface, a wireless network interface, a propagated signal interface, etc.).

The drive unit 722 includes a machine-readable medium 724 on which is stored a set of instructions (i.e. software, firmware, middleware, etc.) 726 embodying any one, or all, of the methodologies described above. The set of instructions 726 is also shown to reside, completely or at least partially, within the main memory 710 and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

Although the present invention has been described in terms of specific exemplary embodiments, it will be appreciated that various modifications and alterations might be made by those skilled in the art without departing from the spirit and scope of the invention. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the widest scope consistent with the principles and novel features disclosed herein.

What is claimed is:

1. A method to provide directions for a user, the method comprising:
receiving a user location;
receiving a first product;
determining, by a computer, a first location associated with the first product;
determining routing directions from the user location to the first location.

2. The method as set forth in claim 1, wherein the first location associated with the first product is a store where the first product may be purchased.

3. The method as set forth in claim 1, wherein the determining of the first location further comprises querying an inventory database of the first location to verify if the first product is available for purchase at the first location.

4. The method as set forth in claim 3, further comprising:
transmitting a notice to the first location if the first product is available for purchase at the first location.

5. The method as set forth in claim 4, wherein the notice comprises information to reserve the first product at the first location for the user.

6. The method as set forth in claim 4, wherein the notice comprises an approximate time of arrival of the user at the first location, the approximate time of arrival is at least partly based on the routing directions.

7. The method as set forth in claim 1, further comprising:
receiving one or more restrictions, wherein the determining of the first location further comprises a verification that the first location satisfies the one or more restrictions.

8. A system, comprising at least one processor and memory, to provide a user goal oriented mapping, the system comprising:
a module to receive an initial user location;
a module to receive a first user goal and a second user goal;
a module to determine a first location to accomplish the first user goal and a second location to accomplish the second user goal;
a module to transmit a first notice to the first location and a second notice to the second location, the first notice comprises information to identify the user and the first user goal and the second notice comprises information to identify the user and the second user goal; and
a module to provide routing directions from the initial user location to the first and second locations.

9. The system as set forth in claim 8, wherein the first notice comprises a first approximate time of arrival of the user at the first location and the second notice comprises a second approximate time of arrival of the user at the second location, the first and second approximate time of arrivals are based on the routing directions.

10. The system as set forth in claim 9, wherein the system comprises:
a module to receive a start time associated with the user, the first and second approximate time of arrival are further based on the start time associated with the user.

11. The system as set forth in claim 8, wherein the information of the first notice and is to be used to reserve a first item to be purchased at the first location and the second notice is to be used to reserve a second item to be purchased at the second location.

12. The system as set forth in claim 8, wherein the system further comprises:
a module to receive one or more time restrictions, the determining of the first location and the second location is further based on the time restrictions.

13. The system as set forth in claim 12, wherein the time restrictions comprises times that the user specifies to arrive at the first location and the second location

14. The system as set forth in claim 13, wherein the system further comprises:
a module to receive first operating hours for the first location and second operating hours for the second location, the determining of the first location and the second location is based on whether the first and second operating hours satisfy the one or more time restrictions.

15. A non-transitory computer readable medium carrying one or more instructions to provide mapping instructions for a user, wherein the one or more instructions, when executed by one or more processors, causes the one or more processors to perform the steps of:
receiving an initial user location;
receiving a first product for the user to purchase;
receiving a second product for the user to purchase;
determining a first location to purchase the first product;
determining a second location to purchase the second product, the determination of the first location and the second location comprises querying an inventory database of a store to determine if the first or second product is available for purchase at the store;
transmitting a first notice to the first location, wherein the first notice comprises information to identify the user and to identify the first product that the user intends to purchase at the first location;
transmitting a second notice to the second location, wherein the second notice comprises information to identify the user and to identify the second product that the user intends to purchase at the second location; and
determining a route from the initial user location to the first and second locations.

16. The non-transitory computer readable medium as set forth in claim 15, wherein the steps further comprise:
receiving a time restriction from the user;
receiving operating hours for the first location;
receiving operating hours for the second location, wherein the determining of the first location and the second location further comprises determining if the operating hours for the first location satisfy the time restriction from the user and if the operating hours for the second location satisfy the time restriction from the user.

17. The non-transitory computer readable medium as set forth in claim 15, wherein the first notice comprises an estimated time for the user to arrive at the first location and the second notice comprises an estimated time for the user to arrive at the second location.

18. The non-transitory computer readable medium as set forth in claim 17, wherein the estimated time is at least partly based off of the routing from the initial user location to the first and second locations.

19. The non-transitory computer readable medium as set forth in claim 15, wherein the first notice and the second notice are to be used by the first location or the second location to reserve the first product or the second product for the user.

20. The non-transitory computer readable medium as set forth in claim 15, wherein the determining of the first location and the second location further comprises a determination that the first product or the second product satisfies a price requirement of the user.
